(19) United States
(12) Patent Application Publication
(10) Pub. No.: US 2026/0288321 A1
(43) Pub. Date: Sep. 24, 2026

(54) INTERACTIVE DIALS WITHIN USER INTERFACES FOR RESOURCE ACCESSIBILITY

(71) Applicant: Chime Financial, Inc., San Francisco, CA (US)

(72) Inventors: Izel Maras, Brooklyn, NY (US); Michael Stumpo, Oakland, CA (US); Tricia Santamaria, Irvine, CA (US); Anthony Tae Jin Lee, Emeryville, CA (US)

(21) Appl. No.: 19/087,151

(22) Filed: Mar. 21, 2025

(51) Int. Cl. G06F 3/04847; G06Q 40/02

(52) U.S. Cl. CPC G06F 3/04847; G06Q 40/02

(57) ABSTRACT

The present disclosure relates to systems, non-transitory computer-readable media, and methods for generating a resource accessibility dial within a user interface. The disclosed systems can periodically determine an available resource delimiter for a user account and display the available resource delimiter within the resource accessibility dial. For example, the disclosed systems can determine the available resource delimiter according to an accumulation rate and an accumulation period associated with the user account. Further, the disclosed systems can modify the resource accessibility dial responsive to receiving an interaction with the resource accessibility dial.

### BRIEF DESCRIPTION OF THE DRAWINGS

The detailed description provides one or more embodiments with additional specificity and detail through the use of the accompanying drawings, as briefly described below.

FIG. 1 illustrates an overview of the dial interface system utilizing a resource accessibility dial to determine a resource quantity in accordance with one or more embodiments.

FIG. 2 illustrates an example graphical user interface including a resource accessibility dial and an available resource delimiter in accordance with one or more embodiments.

FIGS. 3A-3C illustrate example resource accessibility dials within a user interface that includes a first section and a second section in accordance with one or more embodiments.

FIG. 4 illustrates an example resource accessibility dial within a user interface that includes a first section, a second section, and a third section in accordance with one or more embodiments.

FIG. 5 illustrates an example resource accessibility dial within a user interface that includes a first section, a second section, a third section, and a fourth section in accordance with one or more embodiments.

FIG. 6 illustrates a preview of the resource accessibility dial within an overview user interface and the dial interface system generating the resource accessibility dial within a user interface responsive to detecting an interaction with the preview in accordance with one or more embodiments.

FIG. 7 illustrates an environment in which a dial interface system can operate in accordance with one or more embodiments.

FIG. 8 illustrates a flowchart of a series of acts for generating a resource accessibility dial in accordance with one or more embodiments.

FIG. 9 illustrates a block diagram of an example computing device for implementing one or more embodiments of the present disclosure.

FIG. 10 illustrates an example environment for an inter-network facilitation system in accordance with one or more implementations.

### DETAILED DESCRIPTION

This disclosure describes one or more embodiments of a dial interface system that generates a user interface including a resource accessibility dial. To illustrate, in one or more embodiments, the dial interface system determines an available resource delimiter for a user account according to various factors (e.g., account history, resource usage, etc.). Further, the dial interface system can display a resource accessibility dial that includes the resource delimiter dividing the dial into sections or portions. In some cases, the dial interface system can generate the resource availability dial to include two sections: a first section that indicates resource availability up to the available resource delimiter and a second section that indicates projected resource availability beyond the available resource delimiter. The dial interface system can utilize the first section and the second section of the resource accessibility dial to represent resource availability within an accumulation period. Additionally, the dial interface system can receive a user interaction with the resource accessibility dial to modify sizes of various portions (e.g., to indicate different resource availability or quantity).

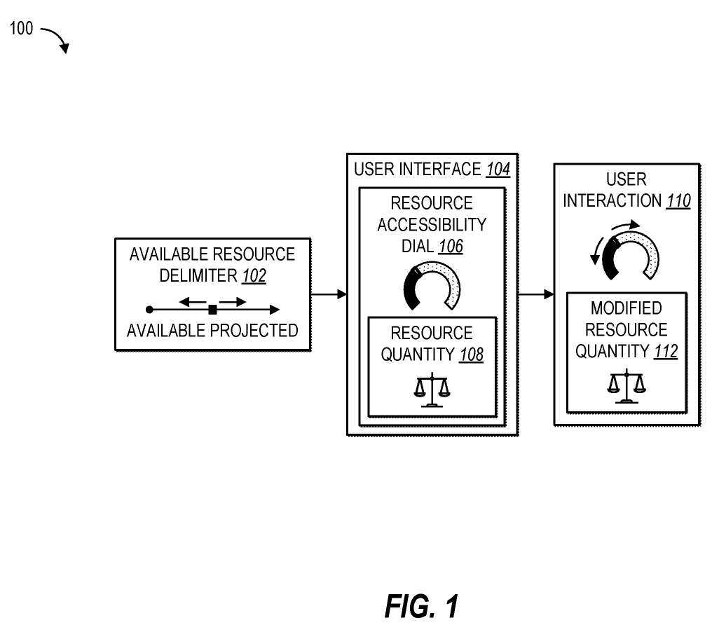

Additional detail will now be provided in relation to illustrative figures portraying example embodiments and implementations of the dial interface system. For example, FIG. 1 illustrates an overview of a process for generating a resource accessibility dial. More specifically, as shown in FIG. 1, the dial interface system can determine an available resource delimiter and can receive an interaction with the resource accessibility dial in accordance with one or more embodiments. Additional detail regarding the acts and processes introduced in relation to FIG. 1 is provided thereafter with reference to subsequent figures.

As shown in FIG. 1, a dial interface system 100 can generate an available resource delimiter 102 to indicate a current resource availability for a user account. The dial interface system 100 can generate the available resource delimiter based on determining resources available to a user account. For example, the dial interface system 100 can determine available resources according to a variety of factors, such as an accumulation rate and an accumulation period associated with the user account. Indeed, the dial interface system 100 can utilize an algorithm to determine a total resource availability for a user account for an accumulation period according to an accumulation rate. Further, the dial interface system 100 can periodically determine the resource availability and a projected resource availability according to the total resource availability for the accumulation period. In some cases, the dial interface system 100 can determine the available resource delimiter periodically within the accumulation period (e.g., such as daily) according to the total resource availability. To illustrate, the dial interface system 100 can utilize the available resource delimiter 102 to indicate an amount of the total resource availability that is currently available. As the accumulation period progresses, the dial interface system 100 can incrementally increase the resource availability by an amount by decreasing the projected resource availability by the amount.

Moreover, as illustrated in FIG. 1, the dial interface system 100 can generate a resource accessibility dial 106 within a user interface 104 (e.g., the dial interface system 100 can display the user interface 104 on a client device). The dial interface system 100 can generate the resource accessibility dial to include a plurality of increments within the resource accumulation period. For example, the dial interface system 100 can generate the plurality of increments according to the periodicity that the dial interface system 100 determines the available resource delimiter within the accumulation period. To illustrate, the dial interface system 100 can determine that the accumulation period includes a number of days, such as ten. The dial interface system 100 can generate the resource accessibility dial 106 with the plurality of increments equal the number of days.

Further, the dial interface system 100 can generate the resource accessibility dial 106 to include a first section that indicates a resource quantity 108 available for the user account up to the available resource delimiter 102. Additionally, the dial interface system 100 can generate the resource accessibility dial 106 to include a second section that indicates a projected resource availability above the available resource delimiter 102. The dial interface system 100 can use the first section and the second section to indicate a cumulative resource availability to a user account within the accumulation period.

Additionally, as illustrated in FIG. 1, the dial interface system 100 can receive a user interaction 110 with the resource accessibility dial 106. Specifically, the dial interface system 100 can generate an interactive element that is selectable (e.g., slidable along an arc of the resource accessibility dial) 106 to modify the resource quantity 108 accessible by the user account. Responsive to receiving an interaction with the resource accessibility dial 106, the dial interface system 100 can update the resource accessibility dial 106 to reflect a modified resource quantity 112 according to the user interaction.

The dial interface system 100 addresses several shortcomings of prior systems. For example, prior systems are navigationally inefficient. Indeed, many prior systems require excessive navigation (e.g., an excessive number of client device interactions) across multiple interfaces and/or applications in order to determine and provide a resource quantity accessible by a user account at a particular point in time. Such systems require yet further interaction to determine and provide projected resource availability beyond what is currently available. Indeed, many existing systems split resource availability displays across multiple interfaces, separating currently available resources from projected or predicted resources. Navigating across the multiple interfaces of existing systems to access these data requires excessive numbers of interactions that could otherwise be reduced with a more efficient interface.

As a byproduct of requiring excessive numbers of interactions across multiple interfaces, many prior systems consume excessive amounts of computer resources as well. Indeed, existing systems that split current and project resource availability into different interfaces must simultaneously run processes for both interfaces and/or must cache (e.g., in CPU memory and/or GPU memory) data for rendering interface elements across both interfaces to facilitate navigating between them to get the complete picture of resource availability. On top of this, the excessive navigations required by prior systems also consume computational resources. Thus, many existing systems consume computational resources that could otherwise be preserved with a more efficient system.

Additionally, some prior systems generate inaccurate or otherwise unreliable resource availability calculations and/or predictions. Indeed, many prior systems have limited access to data sources associated with a user account. For instance, some existing systems are designed solely for a single account system and thus retain information only relating to accounts within the single system. Because individuals often store and access resources in multiple systems, their resource availability extends beyond a single system or a single database. By relying on such limited data contexts, prior systems generate inaccurate or otherwise incomplete representations of resource availability for user accounts.

As described herein, the dial interface system 100 provides several advantages compared to prior systems. To illustrate, rather than requiring navigation across multiple interfaces and/or applications, the dial interface system 100 generates a resource accessibility dial within a user interface to consolidate interactions among applications and interfaces, thereby increasing navigational efficiency. Indeed, the dial interface system 100 utilizes the resource accessibility dial within the user interface to provide a singular location that enables users to interact with available resources at a particular point in time and determine projected resources. By providing a singular element within a user interface (i.e. the resource accessibility dial) that enables multiple functionalities, the dial interface system 100 reduces computational resources (e.g., server bandwidth and computer memory) required to render and cache pixel data associated with the user interface.

Through increasing navigational efficiency, the dial interface system 100 also improves computational efficiency by reducing the consumption of computer resources compared to existing systems. To illustrate, by generating a resource accessibility dial in a user interface that both provides access to available resources and displays projected resource ability, the dial interface system 100 reduces the amount of cached data required to render multiple interface elements across multiple interfaces. Further, the dial interface system 100 reduces the use of computational resources by eliminating the need to navigate between multiple interfaces in order to interact with available resources and further determine projected resource availability.

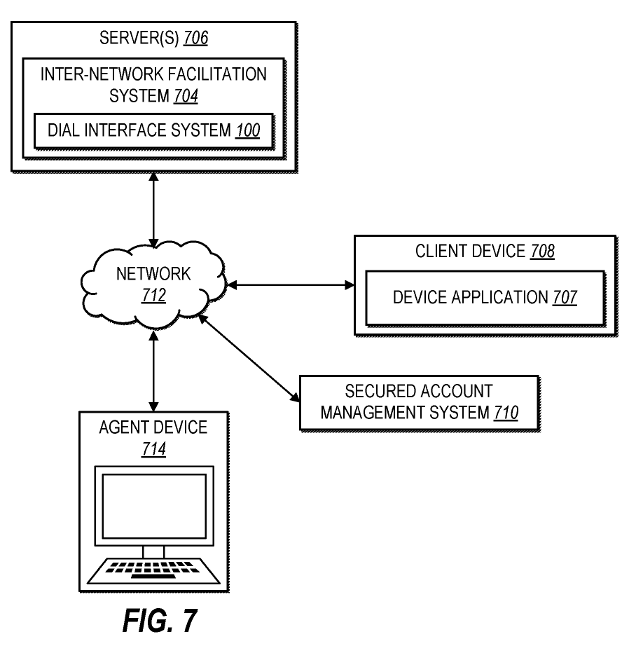

Further, the dial interface system 100 demonstrates improved accuracy compared to prior systems that generate inaccurate and/or unreliable resource availability predictions. To illustrate, through an inter-network facilitation system (e.g., as discussed below with regard to FIG. 7), the dial interface system 100 accesses, analyzes, and utilizes a broad spectrum of data from multiple systems and/or multiple databases to determine current and projected resource availability. By accessing and utilizing more reliable data sources, the dial interface system 100 to generates resource availability predictions that are more accurate compared to prior systems.

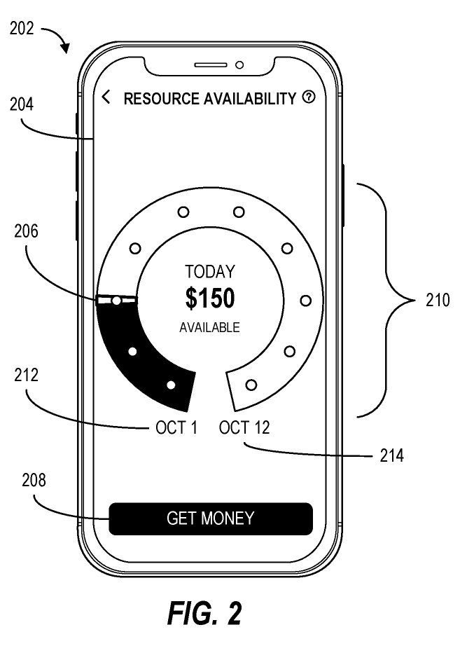

As previously mentioned, the dial interface system 100 can display an available resource delimiter within a user interface. FIG. 2 illustrates the dial interface system 100 generating an available resource delimiter within a resource accessibility dial of a user interface in accordance with one or more embodiments.

As used herein, the term “available resource delimiter” refers to a visual element indicating or delimiting a resource quantity for access by a user account. Specifically, the dial interface system 100 can determine the resource quantity according to user interaction moving the available resource delimiter and/or according to an accumulation rate and an accumulation period associated with the user account. The dial interface system 100 can display the available resource delimiter at a default location within a resource availability dial of a user interface to demarcate a boundary (e.g., the threshold) between resources currently available to the user account at a current point in time within the accumulation period, and projected resource availability at a future date within the accumulation period (e.g., a first section and a second section of a resource accessibility dial). For example, the available resource delimiter can include an interactive user interface element that indicates a currently available portion of a resource, such as a paycheck or an income, that the dial interface system can make immediately available to the user account. Further, the dial interface system 100 can periodically increment the available resource delimiter within resource accessibility dial corresponding to an increase of a threshold of resource availability at a point in time in the accumulation period (e.g., such as a pay period) according to the accumulation rate. Incrementing the available resource delimiter can include automatically adjusting the boundary between the first section and the second section of the resource accessibility dial and/or automatically relocating the interactive user interface element.

Additionally, as used herein, the term “resource accessibility dial” can refer to an element of a graphical user interface that indicates a total resource availability for an accumulation period. Further, the resource accessibility dial can include multiple dynamic sections. Indeed, the resource accessibility dial can include a first section that the dial interface system 100 utilizes to delimit an available resource and provide a user account with immediate access to the resource through an interaction with an interactive element of the resource accessibility dial. Moreover, the resource accessibility dial can include a second section that the dial interface system 100 utilizes to determine and display a projected resource available. The dial interface system 100 can utilize the first section and the second section of the resource accessibility dial to indicate a balance of a total resource availability for the accumulation period. For example, the dial interface system 100 can periodically increase a first size of the first section by an amount and decrease a second size of the second section by the amount to indicate a conversion of a portion of the total resource availability from projected availability to current availability. Additionally, in some embodiments, the dial interface system 100 can generate the resource accessibility dial to include one or more additional sections, such as a third section corresponding to resource unavailability. Further, the dial interface system 100 can utilize the first section, the second section, and the third section of the resource accessibility dial to demarcate or otherwise indicate different types of resource availability (e.g., currently available, projected, and/or unavailable) within the accumulation period.

Additionally, as used herein, the term “machine learning model” refers to a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, random forest models, or neural networks (e.g., deep neural networks).

As shown in FIG. 2, the dial interface system 100 can generate a user interface 204 for display on a client device 202. Further, the dial interface system 100 can generate the user interface 204 to include a resource accessibility dial 210 and an available resource delimiter 206. In some embodiments, the dial interface system 100 can generate the resource accessibility dial 210 to include the available resource delimiter 206. Additionally, the dial interface system 100 can generate the user interface 204 to include a resource acquisition element 208 selectable to immediately provide resources to a user account according to the resource accessibility dial 210.

Additionally, as illustrated in FIG. 2, the dial interface system 100 can generate and include additional features to provide additional functionalities within the user interface 204. For example, the dial interface system 100 can provide an indication 212 a beginning of an accumulation period (e.g., “OCT 1”) in the user interface 204.. Additionally, the dial interface system 100 can provide an indication 214 of an end of the accumulation period (e.g., “OCT 12). Further, the dial interface system 100 can provide a description of the available resource delimiter 206 in the user interface 204 (e.g., “Today $150 Available”). Moreover, the dial interface system 100 can generate the resource accessibility dial 210 to include a plurality of elements equal to a plurality of intervals within the accumulation period.

To illustrate, as shown in FIG. 2, the dial interface system 100 indicates that the accumulation period is from October 1 – 12. The dial interface system 100 can determine the plurality of intervals within the accumulation period. For example, the dial interface system 100 can determine that there are ten intervals in the accumulation period (e.g., corresponding to ten business days within the pay period). The dial interface system 100 can generate the resource accessibility dial 210 to include the plurality of elements equal to the plurality of intervals within the accumulation period. An interval can be an increment of time, including hours, days, weeks, months, or years.

Additionally, the dial interface system 100 can determine to update or otherwise relocate or modify the default location of the available resource delimiter 206 according to the plurality of intervals within the accumulation period. For example, the dial interface system 100 can determine a first available resource quantity according to a first interval of the plurality of intervals of the accumulation period. Upon determining an expiration of an interval of the plurality of intervals (e.g., upon determining that a period of time corresponding to an interval, such as a day), has passed, the dial interface system 100 can update the default location for the available resource delimiter 206. For example, the dial interface system 100 can move or relocate the available resource delimiter 206 (e.g., in a clockwise direction) to thereby increasing a size of a first section of the resource accessibility dial 210.

Additionally, in some embodiments, the dial interface system 100 can generate an interactive element selectable to modify a resource quantity accessible within the dial interface system 100. For example, the dial interface system 100 can enable the available resource delimiter 206 to be interactive and selectable. Indeed, the dial interface system 100 can receive an interaction with the available resource delimiter 206 (e.g., a tap and drag or a slide input) to increase or decrease a selected resource quantity accessible by the user account up to the amount indicated by the available resource delimiter 206.

To illustrate, the dial interface system 100 can generate the available resource delimiter 206 to indicate a threshold of a resource quantity accessible by the user account according to an interval of the accumulation period. Further, the dial interface system 100 can periodically determine the threshold according to intervals within the accumulation period according to an accumulation rate. Additionally, the dial interface system 100 can receive an interaction with the available resource delimiter 206 and/or an interactive element to decrease the resource quantity accessible by the user account below the threshold. In this manner, the dial interface system 100 enables the user account to modify the resource quantity accessible prior to interacting with the resource acquisition element 208.

Further, in some embodiments, the dial interface system 100 can modify the resource quantity accessible by the user account. For instance, the dial interface system 100 can receive a clockwise circular swipe interaction from a user interface element at an origin or beginning of the resource accessibility dial 210 (e.g., the bottom-left of the horseshoe shape) towards and/or up to the threshold indicated by the available resource delimiter to modify the resource quantity accessible by the user account. In some cases, the dial interface system 100 receives a counterclockwise circular swipe interaction to modify the resource quantity accessible by the user account below the threshold (e.g., a counterclockwise circular motion). Sometimes the interaction originates from the threshold indicated by the available resource delimiter 206 and moves the available resource delimiter 206 to end somewhere in the resource accessibility dial between the threshold and the origin and/or beginning of the resource accessibility dial 210.

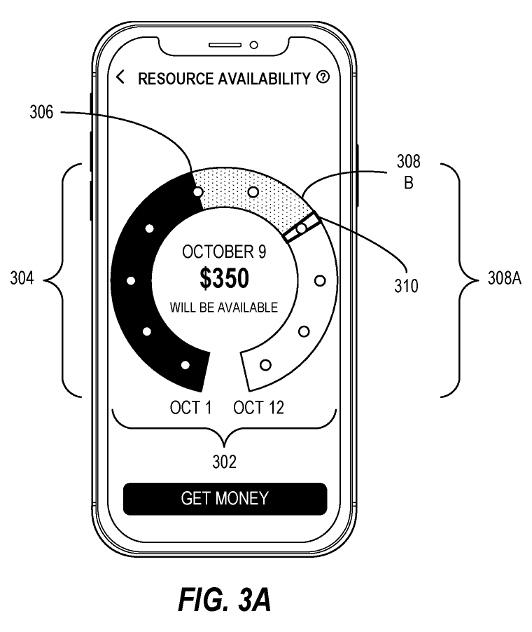

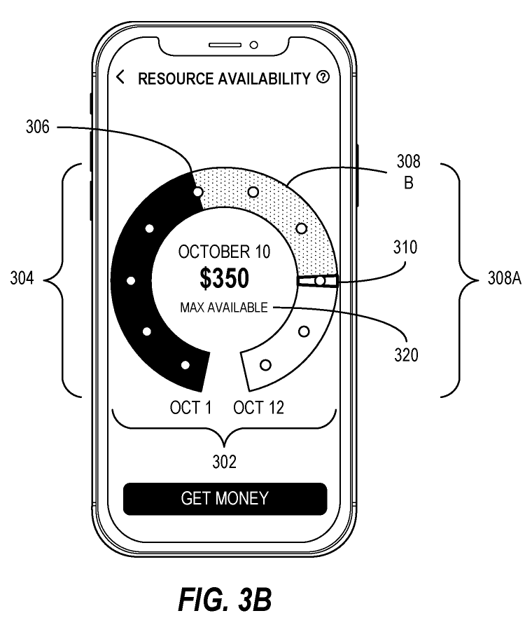

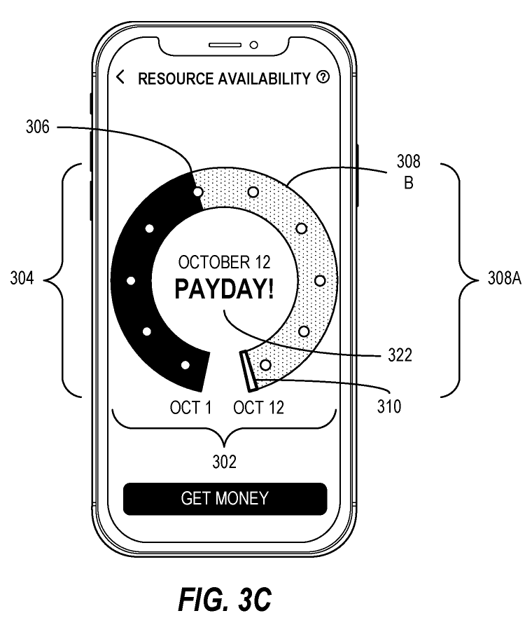

As previously mentioned, the dial interface system 100 can generate a resource accessibility dial that includes a first section and a second section. FIGS. 3A-3C illustrate the dial interface system 100 generating a resource accessibility dial within a user interface that includes a first section that indicates resource accessibility up to an available resource delimiter and a second section that indicates projected resource availability in accordance with one or more embodiments.

As shown in FIG. 3A, the dial interface system 100 can generate a resource accessibility dial 302 to include a first section 304 and a second section 308A. Specifically, the dial interface system 100 can utilize the first section 304 to indicate immediate resource availability up to an available resource delimiter 306. Further, the dial interface system 100 can utilize the second section 308A to indicate a projected resource availability at one or more additional intervals within an accumulation period. Further, the dial interface system 100 can receive an interaction with an interactive element 310 to generate a subsection 308B of the second section 308A that indicates a portion of the projected resource availability. For example, the dial interface system 100 can receive an interaction with the interactive element 310 originating from the available resource delimiter 306 and extending into the second section 308A. Based on receiving the interaction, the dial interface system 100 can generate the subsection 308B to indicate projected resource availability for the user account according to one or more intervals contained in the subsection 308B. Further, in some embodiments, the interaction can extend the interactive element 310 to an end of the second section 308A.

As illustrated in FIG. 3A, the dial interface system 100 can utilize a first set of pixels reflecting a first format (e.g., color, pattern, or other visualization) to generate the first section 304. Additionally, the dial interface system 100 can utilize a second set of pixels reflecting a second format that is visually distinct from the first format to generate the second section 308A and/or the subsection 308B. To illustrate, the dial interface system 100 can generate the first section 304 to be visually distinct from the second section 308A (and/or the subsection 308B) in a variety of ways. For example, the dial interface system 100 can generate the first section 304 to be a first color, such as light green, and the second section 308A (and/or the subsection 308B) to be a second color, such as dark green. Moreover, the dial interface system 100 can generate the first set of pixels reflecting a first format, such as a first pattern (e.g., dashed or solid vertical lines, dashed or solid horizontal lines, a combination of dashed vertical lines and dashed horizontal lines, or dotted, among others), and can generate the second set of pixels reflecting a second format visually distinct from the first format.

Further, as shown in FIG. 3A, the dial interface system 100 can generate the first section 304 to be visually distinct from the second section 308A (and/or the subsection 308B) by generating the first set of pixels for the first section 304 to be a color (e.g., black) and generating the second set of pixels for the second section 308A (and/or the subsection 308B) to be a pattern (e.g., a dotted pattern). Additionally, the dial interface system 100 can utilize the available resource delimiter 306 to demarcate or otherwise visually indicate a separation between the first section 304 and the second section 308A (and/or the subsection 308B).

Moreover, the dial interface system 100 can generate the subsection 308B responsive to an input from a user. For example, the dial interface system 100 can generate the interactive element 310 within the resource accessibility dial 302. The dial interface system 100 can receive the user action, such as a circular swipe interaction, along an arc of the resource accessibility dial 302. In some embodiments, the dial interface system 100 can receive the circular swipe interaction with the interactive element 310 to generate the subsection 308B by extending beyond the available resource delimiter 306. Based on generating the subsection 308B, the dial interface system 100 can define and/or otherwise display an available resource quantity that includes an available amount and a projected amount. Further, in some embodiments, the dial interface system 100 can generate the second set of pixels by converting the second set of pixels from a previous format to the second format.

For example, as shown in FIG. 3A, responsive to receiving the circular swipe interaction and generating the subsection 308B, the dial interface system 100 can provide an indication of resource availability (e.g., “OCTOBER 9 $350 WILL BE AVAILABLE”). The indication of resource availability can include a combination of an available amount of resources corresponding to the first section 304 and a projected amount of available resources according to an interval of the accumulation period corresponding to the subsection 308B. Moreover, in some embodiments, the dial interface system 100 can generate the indication of resource availability to include a bifurcation between the available amount of resources and the projected amount. To illustrate, in addition to defining the resource quantity available as a lump sum available at the interval within the accumulation period (e.g., “OCTOBER 9 $350 WILL BE Available”), the dial interface system 100 can additionally indicate how much of the resource quantity is currently available and how much is projected. For example, the dial interface system 100 can delineate that a first portion of the resource quantity corresponding to the first section 304 is currently available as of a current interval in the accumulation period, and that a second portion corresponding to the subsection 308B will be available at an upcoming interval within the accumulation period. To further illustrate, the dial interface system 100 can generate a notification or indication to identify that of the $350, $250 are available, and an additional $100 will be available as of October 9.

In some embodiments, the dial interface system 100 can determine a threshold for projected resource availability within the accumulation period. FIG. 3B illustrates the dial interface system 100 providing an indication of the threshold within a user interface of a client device. As previously discussed, the dial interface system 100 can generate the resource accessibility dial 302 to include a first section 304 and a second section 308A. Further, the dial interface system 100 can generate the subsection 308B of the second section 308A responsive to receiving an interaction with the interactive element 310. Responsive to generating the subsection, the dial interface system 100 can provide an indication of resource availability.

In some embodiments, the dial interface system 100 can provide the indication of resource availability by providing an indication 320 of a threshold or cap of projected resource availability within the accumulation period. For example, the dial interface system 100 can determine a threshold or cap of resource availability within the accumulation period prior to an end of the accumulation period. Indeed, as previously discussed, the dial interface system 100 can incrementally increase resource availability at intervals within the accumulation period. In some embodiments, the dial interface system 100 can determine to set the threshold or the cap for projected resource availability at an interval within the accumulation period as opposed to setting the threshold at an interval at an end of the accumulation period.

To illustrate, as discussed in FIG. 3A, the dial interface system 100 can determine and provide an initial indication of a projected resource availability at a first interval within the accumulation period (e.g., $350 AVAILABLE OCTOBER 9). As shown in FIG. 3B, the dial interface system 100 can determine provide the indication 320 of projected resource ability at a second interval within the accumulation period that identifies an equivalent amount of projected resource availability as the initial indication. To elaborate, even though the first interval within the accumulation period (e.g., OCTOBER 9) is a different interval than the second interval within the accumulation period (e.g., OCTOBER 10), the initial indication of resource availability and the indication 320 identify the same amount of projected resource availability (e.g., the threshold). Thus, in some embodiments, the dial interface system 100 can determine the threshold or cap of projected resource availability, and increment the resource availability such that the dial interface system 100 meets the threshold at an interval within the accumulation period as opposed to at an interval at an end of the accumulation period. In some cases, the dial interface system 100 determines or sets the threshold or the cap based on previous user account behavior for withdrawing resources and/or based on a history of resource availability from previous resource accumulation periods.

Additionally, in some embodiments, the dial interface system 100 can map the interaction with the interactive element 310 to an element of the plurality of elements of the resource accessibility dial 302 (e.g., that correspond to the plurality of intervals of the accumulation period). For example, the dial interface system 100 can determine that the interaction with interactive element 310 ends within a threshold distance of an element of the plurality of elements of the resource accessibility dial 302. Based on determining that the interaction ends within the threshold distance of the element of the plurality of elements the dial interface system 100 can implement a “snap-to” function to snap or otherwise map the available resource delimiter to the element of the plurality of elements. Additionally or alternatively, the dial interface system 100 can generate each of the plurality of elements to include a “snap-to” function that the dial interface system 100 can use to snap or otherwise map the interactive element 310 to an element of the plurality of elements responsive to determining that the interactive element 310 is within the threshold distance of the element of the plurality of elements. Further, the dial interface system 100 can generate a “bounce-back” animation that displays the user interactive element snapping to the element of the plurality of elements responsive to determining that the user interactive element 310 is within the threshold.

Further, in some embodiments, the dial interface system 100 can provide an indication of an end of the accumulation period. FIG. 3C illustrates the dial interface system 100 providing an indication of the end of the accumulation period responsive to receiving a circular swipe interaction with an interactive element in accordance with one or more embodiments.

As shown in FIG. 3C and as previously discussed, the dial interface system 100 can generate the resource accessibility dial 302 to include the first section 304 and the second section 308A. Further, the dial interface system 100 can separate the first section 304 from the second section 308A using the available resource delimiter 306. The available resource delimiter 306 can include the interactive element 310. Responsive to receiving an interaction with the interactive element 310 (e.g., a clockwise circular swipe along an arc of the resource accessibility dial 302), the dial interface system 100 can generate the subsection 308B of the second section 308A. Responsive to determining that the interaction with the interactive element 310 extends to an end (e.g., a limit) of the resource accessibility dial 302, the dial interface system 100 can generate and provide an indication 322 of an end of the accumulation period (e.g., “OCTOBER 12 PAYDAY!” In some embodiments, the dial interface system 100 can generate and provide the indication 322 responsive to receiving an interaction (e.g., a tap or a click) with the end of the resource accessibility dial 302.

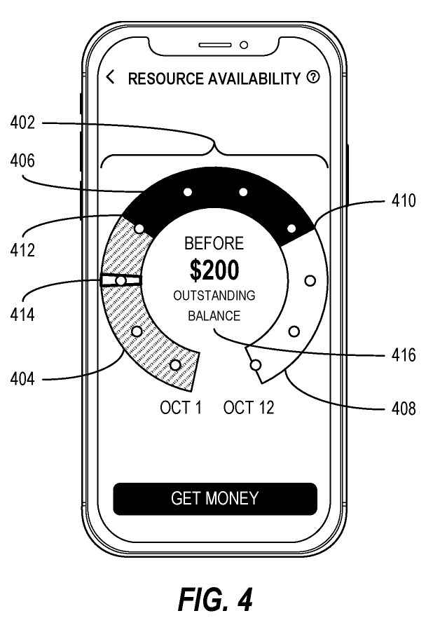

As previously mentioned, in some embodiments, the dial interface system 100 can generate a first section, a second, and a third section in a resource accessibility dial. FIG. 4 illustrates the dial interface system 100 generating a resource accessibility dial including three different sections in a user interface in accordance with one or more embodiments.

As illustrated in FIG. 4, the dial interface system 100 can generate a resource accessibility dial 402 within a user interface of a client device. As discussed above with regard to FIG. 2, the dial interface system 100 can generate a first section 406 of the resource accessibility dial 402 to indicate a resource quantity accessible by a user account up to an available resource delimiter 410 according to a current interval of an accumulation period. Further, as discussed above with regard to FIGS. 3A-3B, the dial interface system 100 can generate a second section 408 of the resource accessibility dial 402 to indicate a projected resource availability (e.g., above the available resource delimiter 410) according to an interval of the accumulation period beyond the current interval. Further, the dial interface system 100 can generate a third section 404 of the resource accessibility dial 402. Specifically, the dial interface system 100 can generate the third section 404 to indicate an unavailable resource quantity.

For example, as discussed above with regard to FIG. 2, the dial interface system 100 can provide access to an available resource quantity through the resource accessibility dial 402 and a resource acquisition element (e.g., “Get Money,” the resource acquisition element 208 of FIG. 2). Responsive to receiving an interaction with the resource acquisition element, the dial interface system 100 can generate the third section 404 to indicate the unavailable resource quantity (e.g., to indicate the amount of resources utilized in the interaction with the resource acquisition element). Indeed, in some embodiments, the dial interface system 100 can generate the third section 404 by converting a third set of pixels to reflect a third format from a first set of pixels that reflects a first format corresponding to the first section 406 of the resource accessibility dial. The third format can be visually distinct from the first format and a second format corresponding to the second section 408.

Additionally, the dial interface system 100 can generate an unavailable resource delimiter 412 to visually separate the first section 406 from the third section 404. Additionally, responsive to additional interactions with the resource acquisition element, the dial interface system 100 can modify the sizes of the first section 406 and the third section 404 by converting a subset of the first section 406 from the first format to the third format. In this manner, the dial interface system 100 can utilize the third section 404 to dynamically represent an amount of resources made available by the dial interface system 100 within the accumulation period and utilized by the user account.

In some embodiments, the available resource delimiter 410 can include an interactive element 414. Responsive to receiving an interaction with the interactive element 414 (such as a counterclockwise circular swipe that starts at or near the available resource delimiter and ends in the third section 404), the dial interface system 100 can generate and display an indication 416 of resource unavailability (e.g., “BEFORE $200 OUTSTANDING BALANCE). The dial interface system 100 can determine the indication 416 according to previous interactions with resource acquisition elements within the user interface.

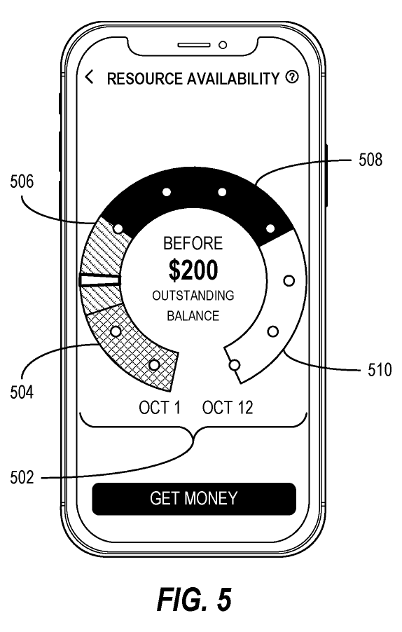

As previously mentioned, in some embodiments, the dial interface system 100 can generate a resource accessibility dial to include four sections. As illustrated in FIG. 5, the dial interface system 100 can generate a resource accessibility dial to include a first section, a second section, a third section, and a fourth section in accordance with one or more embodiments.

As discussed previously with regard to FIGS. 2-4, the dial interface system 100 can generate a resource accessibility dial 502 in a user interface of a client device. Specifically, the dial interface system 100 can generate the resource accessibility dial 502 to include a first section 508 corresponding to a resource quantity accessible by a user account according to a current interval of an accumulation period. Further, the dial interface system 100 can generate a second section 510 (and/or a subsection of the second section) of the resource accessibility dial 502 to indicate projected resource availability. Further, the dial interface system 100 can generate an available resource delimiter that demarcates a threshold between resource availability and projected resource availability (e.g., the first section 508 and the second section 510). Responsive to receiving an interaction with the interactive element the dial interface system 100 can generate the second section 510 (and/or a subsection of the second section) of the resource accessibility dial to indicate a resource quantity that includes an available amount as of the current interval of the accumulation period and a projected amount associated with a future interval within the accumulation period. Additionally, responsive to receiving an interaction with a resource acquisition element, the dial interface system 100 can generate a third section 506 of the resource accessibility dial by converting a subset of pixels of the first section 508 corresponding to a first visual format to a third set of pixels corresponding to a third format that is visually distinct from other formats in the resource accessibility dial 502 (e.g., such as a second format corresponding to the second section 510 or a fourth format corresponding to a fourth section 504). To summarize, the dial interface system 100 can generate the first section 508, the second section 510, and the third section 506 to represent various types of resource accessibility (e.g., unavailable, available, and/or projected) within the accumulation period.

In addition, as shown in FIG. 5, the dial interface system 100 can generate the fourth section 504 to indicate determined or suggested resource unavailability due to one or more types of interactions. For example, the dial interface system 100 can generate the fourth section 504 to indicate resource unavailability due to a previous interaction with an inter-network facilitation system (e.g., the inter-network facilitation system 704 of FIG. 7, discussed below). The dial interface system 100 can generate the fourth section comprising a fourth set of pixels reflecting a fourth format that is visually distinct from other formats in the resource accessibility dial 502 (e.g., a first format corresponding to the first section 508, a second format corresponding to the second section 510, a third format corresponding to the third section 506, etc.). Further, the dial interface system 100 can utilize a plurality of sets of pixels reflecting a plurality of formats that are visually distinct from each other to reflect or otherwise identify one or more causes of resource unavailability. Additionally, the dial interface system 100 can utilize an unavailable resource delimiter to delineate or otherwise demarcate a difference between unavailable resources (regardless of the source of the unavailable resource), and available resources.

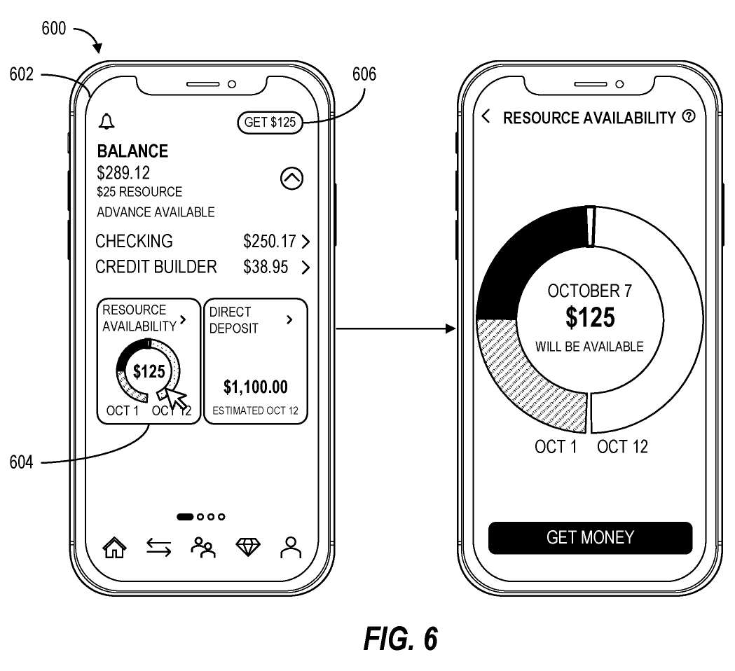

As previously mentioned, in some embodiments the dial interface system 100 can generate a preview of the resource accessibility dial. As shown in FIG. 6, the dial interface system 100 can generate the preview of the resource accessibility dial in an overview user interface and generate the resource accessibility dial in a user interface responsive do detecting an interaction with the preview in accordance with one or more embodiments.

As illustrated in FIG. 6, the dial interface system 100 can generate a preview 604 of a resource accessibility dial in an overview user interface 602 of a client device 600. The dial interface system 100 can utilize the overview user interface 602 to display additional information relating to resource availability for the user account. Further, the dial interface system 100 can include the preview 604 of the resource accessibility dial. The preview 604 can include a first section, a second section, and/or a third section of the resource accessibility dial. Additionally, the preview 604 can include an available resource delimiter and/or a description or other indication of the available resource delimiter (e.g., “$125).

Additionally, the dial interface system 100 can include a preview resource acquisition element 606 (e.g., “Get $125) in the overview user interface 602 to enable a user account to access a resource quantity equal to the available resource delimiter. Responsive to an interaction with the preview resource acquisition element 606, the dial interface system 100 can provide the user with access to the resource quantity and modify modify the preview 604 of the resource accessibility dial by converting the first section to the third section.

Additionally, responsive to detecting an interaction (e.g., a tap or a click) with the preview 604 of the resource availability dial, the dial interface system 100 can generate the resource accessibility dial in a new user interface.

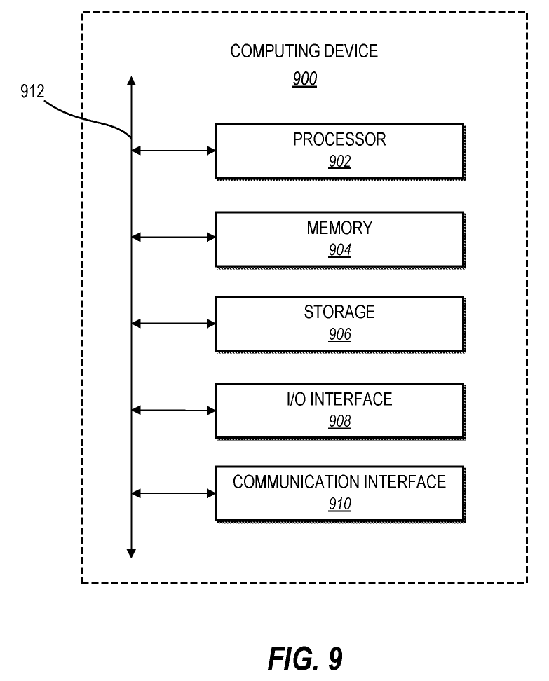

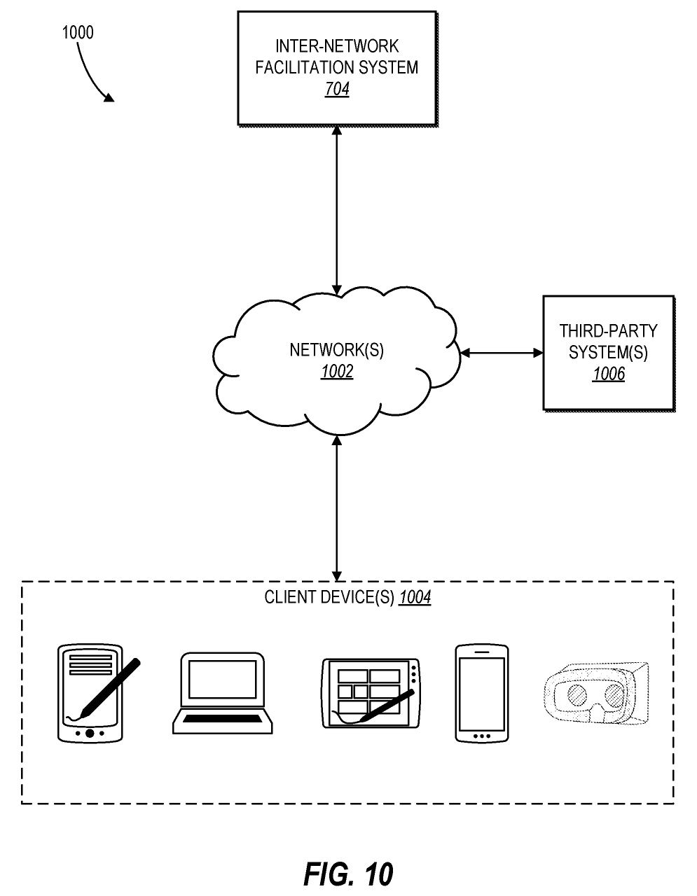

FIG. 7 illustrates a block diagram of a system environment for implementing the dial interface system 100 in accordance with one or more embodiments. As shown in FIG. 7, the environment includes server(s) 706 implementing the dial interface system 100 part of an inter-network facilitation system 704. The environment of FIG. 7 further includes a client device 708, a device application 707, an agent device 714, and a secured account management system 710. The server(s) 706 can include one or more computing devices to implement the dial interface system 100. Additional description regarding the illustrated computing devices (e.g., the server(s) 706, the client device 708, the agent device 714 and/or the secured account management system 710) is provided with respect to FIGS. 9-10 below.

As shown, the dial interface system 100 utilizes the network 712 to communicate with the client device 708, the agent device 714, and/or the secured account management system 710. The network 712 may comprise a network as described in relation to FIGS. 9-10. For example, the dial interface system 100 communicates with the client device 708 to generate a user interface including a resource accessibility dial, and/or to receive digital communication data, including digital images. Indeed, the inter-network facilitation system 704 or the dial interface system 100 can generate a resource accessibility on the client device 708 or can facilitate a session between the agent device 714 and the client device 708.

As described in greater detail below (e.g., in relation to FIG. 10), the inter-network facilitation system 704 can manage interactions across multiple devices, providers, and computer systems. For example, the inter-network facilitation system 704 can execute transactions across various third-party systems such as a banking entities, automated transaction machines, or payment providers. The inter-network facilitation system 704 can also maintain and manage digital accounts for client devices/users to store, manage, and/or transfer funds to other users.

To facilitate generating a user interface including a resource accessibility dial, instructions, and/or explanations, in some embodiments, the inter-network facilitation system 704 or the dial interface system 100 communicates with the secured account management system 710. More specifically, the inter-network facilitation system 704 or the dial interface system 100 determines the identity and permissions of the client device 708 by communicating with the secured account management system 710. The dial interface system 100 can determine permissions of the client device 708 prior to disclosing secure information to the client device 708. For example, the inter-network facilitation system 704 or the dial interface system 100 accesses a secured account maintained by the secured account management system 710 (e.g., remotely from the server(s) 706).

In one or more embodiments, the inter-network facilitation system 704 or the dial interface system 100 communicates with the secured account management system 710 in response to the dial interface system 100 receiving data (e.g., a communication and corresponding account data) from the client device 708. In particular, the inter-network facilitation system 704 or the dial interface system 100 provides an indication of a secured account associated with a digital account to indicate that the client device 708 is authorized to receive information pertaining to the digital account. In addition, the inter-network facilitation system 704 or the dial interface system 100 communicates with the secured account management system 710 to determine permissions and/or activity of the client device 708. For example, the inter-network facilitation system 704 or the dial interface system 100 provide information to the client device 708 such as direct deposit status, digital account updates, device fee information, check status, interaction history, order status, activation, etc.

As indicated by FIG. 7, the client device 708 includes the device application 707. In particular, the device application 707 can include a web application, a native application installed on the client device 708 (e.g., a mobile application, a desktop application, etc.), or a cloud-based application where all or part of the functionality is performed by the server(s) 706. In some embodiments, the inter-network facilitation system 704 or the dial interface system 100 communicates with the client device 708 through the device application 707. This communication for example, receives and provides information including digital communication data, digital images, direct deposit status, digital account updates, device fee information, check status, interaction history, order status, activation, etc. Additionally, the dial interface system 100 can provide digital account information and secured account information for display within a graphical user interface associated with the device application 707 or can provide digital account information via other methods.

As shown in FIG. 7, the client device 708 implements the device application 707 in conjunction with interaction with the inter-network facilitation system 704 or the dial interface system 100. For example, the inter-network facilitation system 704 or the dial interface system 100 can monitor the activities of the device application 707. In particular, these activities can include events such as communications on the application 707, ongoing calls associated with the user account, time spent on device application 707, recently viewed pages on device application 707, the most recent activation activity of the device application 707, etc.

Although FIG. 7 illustrates the environment having a particular number and arrangement of components associated with the dial interface system 100, in some embodiments, the environment may include more or fewer components with varying configurations. For example, in some embodiments, the inter-network facilitation system 704 or the dial interface system 100 can communicate directly with the client device 708, device application 707, and/or the secured account management system 710, bypassing the network 712. In these or other embodiments, the inter-network facilitation system 704 or the dial interface system 100 can be implemented (entirely on in part) on the client device 708. Additionally, the inter-network facilitation system 704 or the dial interface system 100 can include or communicate with a database for storing information, such as direct deposit status, digital account updates, device fee information, check status, interaction history, order status, activation, and/or other information described herein.

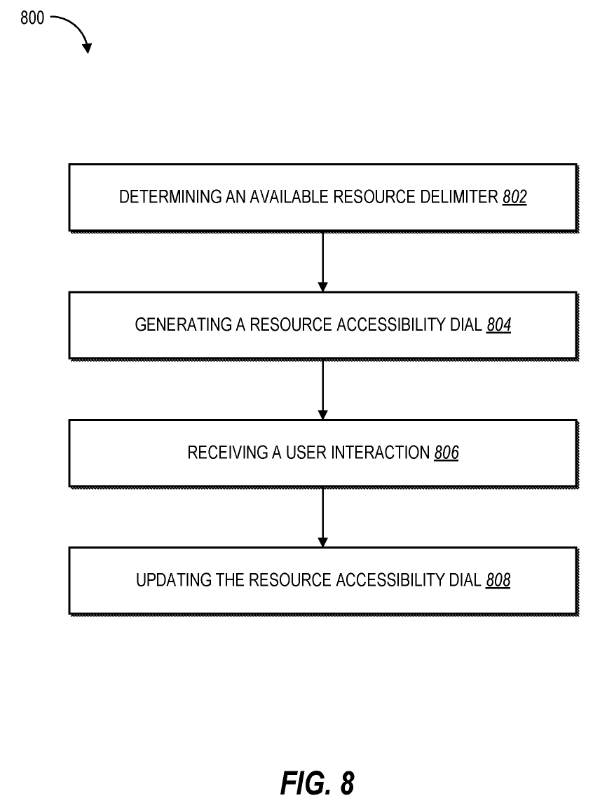

FIGS. 1-7, the corresponding text, and the examples provide a number of different methods, systems, devices, and non-transitory computer-readable media of the communication validation system. In addition to the foregoing, one or more embodiments can also be described in terms of flowcharts comprising acts for accomplishing a particular result, as shown in FIG. 8. FIG. 8 may be performed with more or fewer acts. Further, the acts may be performed in differing orders. Additionally, the acts described herein may be repeated or performed in parallel with one another or parallel with different instances of the same or similar acts.

As mentioned, FIG. 8 Illustrates a flowchart of a series of acts 800 for generating a resource accessibility dial in a user interface in accordance with one or more embodiments. While FIG. 8 illustrates acts according to one embodiment, alternative embodiments may omit, add to, reorder, and/or modify any of the acts shown in FIG. 8. The acts of FIG. 8 can be performed as part of a method (e.g., a computer-implemented method). Alternatively, a non-transitory computer-readable medium can comprise instructions that, when executed by one or more processors, cause a computing device to perform the acts of FIG. 8. In some embodiments, a system can perform the acts of FIG. 8.

As shown in FIG. 8, a series of acts 800 can include an act 802 of determining an available resource delimiter. More specifically, the act 802 can include determining an available resource delimiter for a user account according to an accumulation rate and an accumulation period associated with the user account.

In addition, the series of acts 800 can include an act 804 of generating a resource accessibility dial. More specifically, the act 804 can include generating, for display within a user interface on a client device, a resource accessibility dial comprising an interactive element selectable to modify a resource quantity accessible by the user account, wherein the resource accessibility dial is divided into a first section indicating resource availability up to the available resource delimiter and a second section indicating projected resource availability above the available resource delimiter.

Further, the series of acts 800 can include an act 806 of receiving a user interaction. More specifically, the act 806 can include receiving, from the client device, a user interaction with the resource accessibility dial modifying the resource quantity indicated by the resource accessibility dial.

Moreover, the series of acts 800 can include an act 808 of updating the resource accessibility dial. More specifically, the act 808 can include updating, within the user interface on the client device, the resource accessibility dial to reflect a modified resource quantity according to the user interaction.

Additionally, in one or more embodiments, the series of acts 800 can include generating the first section comprising a first set of pixels reflecting a first format. In some embodiments, the series of acts 800 can also include generating the second section comprising a second set of pixels reflecting a second format visually distinct from the first format.

Further, the series of acts 800 can include generating, for display as part of the resource accessibility dial, a third section indicating an unavailable resource quantity, wherein the third section is separated from the first section by an unavailable resource delimiter and the first section is separated from the second section by the available resource delimiter. Additionally, the series of acts 800 can include modifying a size of the first section according to the unavailable resource quantity.

In some embodiments, the series of acts 800 can include receiving a circular swipe interaction along an arc of the resource accessibility dial to set the resource quantity.

Also, in one or more embodiments, the series of acts 800 can include wherein the circular swipe interaction extends beyond the available resource delimiter to define the resource quantity including an available amount and a projected amount.

In addition, the series of acts 800 can include determining an accumulation of resources associated with the user account according to the accumulation rate at a point in time within the accumulation period.

Further, the series of acts 800 can include generating a preview of the resource accessibility dial for display within an overview user interface. Moreover, the series of acts 800 can include generating the resource accessibility dial for display within the user interface responsive to receiving a user interaction with the preview of the resource accessibility dial.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates, in block diagram form, an exemplary computing device 900 (e.g., the server(s) 706, the client device 708, and/or the agent device 714) that may be configured to perform one or more of the processes described above. As shown by FIG. 9, the computing device can comprise a processor 902, memory 904, a storage device 906, an I/O interface 908, and a communication interface 910. In certain embodiments, the computing device 900 can include fewer or more components than those shown in FIG. 9. Components of computing device 900 shown in FIG. 9 will now be described in additional detail.

In particular embodiments, processor(s) 902 includes hardware for executing instructions, such as those making up a computer program. As an example, and not by way of limitation, to execute instructions, processor(s) 902 may retrieve (or fetch) the instructions from an internal register, an internal cache, memory 904, or a storage device 906 and decode and execute them.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 904 may be internal or distributed memory.

The computing device 900 includes a storage device 906 includes storage for storing data or instructions. As an example, and not by way of limitation, storage device 906 can comprise a non-transitory storage medium described above. The storage device 906 may include a hard disk drive (“HDD”), flash memory, a Universal Serial Bus (“USB”) drive or a combination of these or other storage devices.

The computing device 900 also includes one or more input or output interface 908 (or “I/O interface 908”), which are provided to allow a user (e.g., requester or provider) to provide input to (such as user strokes), receive output from, and otherwise transfer data to and from the computing device 900. The I/O interface 908 may include a mouse, keypad or a keyboard, a touch screen, camera, optical scanner, network interface, modem, other known I/O devices or a combination of such I/O interface 908. The touch screen may be activated with a stylus or a finger.

The I/O interface 908 may include one or more devices for presenting output to a user, including, but not limited to, a graphics engine, a display (e.g., a display screen), one or more output providers (e.g., display providers), one or more audio speakers, and one or more audio providers. In certain embodiments, interface 908 is configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 can provide one or more interfaces for communication (such as, for example, packet-based communication) between the computing device and one or more other computing devices 900 or one or more networks. As an example, and not by way of limitation, communication interface 910 may include a network interface controller (“NIC”) or network adapter for communicating with an Ethernet or other wire-based network or a wireless NIC (“WNIC”) or wireless adapter for communicating with a wireless network, such as a WI-FI. The computing device 900 can further include a bus 912. The bus 912 can comprise hardware, software, or both that connects components of computing device 900 to each other.

FIG. 10 illustrates an example network environment 1000 of the inter-network facilitation system 704. The network environment 1000 includes a client device 1004 (e.g., client device 708, agent device 714), an inter-network facilitation system 704, and a third-party system 1006 connected to each other by a network 1002. Although FIG. 10 illustrates a particular arrangement of the client device 1004, the inter-network facilitation system 704, the third-party system 1006, and the network 1002, this disclosure contemplates any suitable arrangement of client device 1004, the inter-network facilitation system 704, the third-party system 1006, and the network 1002. As an example, and not by way of limitation, two or more of client device 1004, the inter-network facilitation system 704, and the third-party system 1006 communicate directly, bypassing network 1002. As another example, two or more of client device 1004, the inter-network facilitation system 704, and the third-party system 1006 may be physically or logically co-located with each other in whole or in part.

Moreover, although FIG. 10 illustrates a particular number of client devices 1004, inter-network facilitation systems 704, third-party systems 1006, and networks 1002, this disclosure contemplates any suitable number of client devices 1004, inter-network facilitation system 704, third-party systems 1006, and networks 1002. As an example, and not by way of limitation, network environment 1000 may include multiple client devices 1004, inter-network facilitation system 704, third-party systems 1006, and/or networks 1002.

This disclosure contemplates any suitable network 1002. As an example, and not by way of limitation, one or more portions of network 1002 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1002 may include one or more networks.

Links may connect client device 1004, dial interface system 100, and third-party system 1006 to network 1002 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1000. One or more first links may differ in one or more respects from one or more second links.

In particular embodiments, the client device 1004 may be an electronic device including hardware, software, or embedded logic components or a combination of two or more such components and capable of carrying out the appropriate functionalities implemented or supported by client device 1004. As an example, and not by way of limitation, a client device 1004 may include any of the computing devices discussed above in relation to FIG. 9. A client device 1004 may enable a network user at the client device 1004 to access network 1002. A client device 1004 may enable its user to communicate with other users at other client devices 1004.

In particular embodiments, the client device 1004 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1004 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1004 one or more Hyper Text Markup Language (“HTML”) files responsive to the HTTP request. The client device 1004 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 704 may be a network-addressable computing system that can interface between two or more computing networks or servers associated with different entities such as financial institutions (e.g., banks, credit processing systems, ATM systems, or others). In particular, the inter-network facilitation system 704 can send and receive network communications (e.g., via the network 1002) to link the third-party-system 1006. For example, the inter-network facilitation system 704 may receive authentication credentials from a user to link a third-party system 1006 such as an online bank account, credit account, debit account, or other financial account to a user account within the inter-network facilitation system 704. The inter-network facilitation system 704 can subsequently communicate with the third-party system 1006 to detect or identify balances, transactions, withdrawal, transfers, deposits, credits, debits, or other transaction types associated with the third-party system 1006. The inter-network facilitation system 704 can further provide the aforementioned or other financial information associated with the third-party system 1006 for display via the client device 1004. In some cases, the inter-network facilitation system 704 links more than one third-party system 1006, receiving account information for accounts associated with each respective third-party system 1006 and performing operations or transactions between the different systems via authorized network connections.

In particular embodiments, the inter-network facilitation system 704 may interface between an online banking system and a credit processing system via the network 1002. For example, the inter-network facilitation system 704 can provide access to a bank account of a third-party system 1006 and linked to a user account within the inter-network facilitation system 704. Indeed, the inter-network facilitation system 704 can facilitate access to, and transactions to and from, the bank account of the third-party system 1006 via a client application of the inter-network facilitation system 704 on the client device 1004. The inter-network facilitation system 704 can also communicate with a credit processing system, an ATM system, and/or other financial systems (e.g., via the network 1002) to authorize and process credit charges to a credit account, perform ATM transactions, perform transfers (or other transactions) across accounts of different third-party systems 1006, and to present corresponding information via the client device 1004.

In particular embodiments, the inter-network facilitation system 704 includes a model for approving or denying transactions. For example, the inter-network facilitation system 704 includes an acceptance probability machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 704 and/or one or more third-party systems 1006), the inter-network facilitation system 704 can utilize the acceptance approval machine learning model to generate a prediction (e.g., a percentage likelihood) of approval or denial of a transaction (e.g., a deposit, a withdrawal, a transfer, or a purchase) across one or more networked systems.

The inter-network facilitation system 704 may be accessed by the other components of network environment 1000 either directly or via network 1002. In particular embodiments, the inter-network facilitation system 704 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the inter-network facilitation system 704 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1004, or an inter-network facilitation system 704 to manage, retrieve, modify, add, or delete, the information stored in data store.

In particular embodiments, the inter-network facilitation system 704 may provide users with the ability to take actions on various types of items or objects, supported by the inter-network facilitation system 704. As an example, and not by way of limitation, the items and objects may include financial institution networks for banking, credit processing, or other transactions, to which users of the inter-network facilitation system 704 may belong, computer-based applications that a user may use, transactions, interactions that a user may perform, or other suitable items or objects. A user may interact with anything that is capable of being represented in the inter-network facilitation system 704 or by an external system of a third-party system, which is separate from inter-network facilitation system 704 and coupled to the inter-network facilitation system 704 via a network 1002.

In particular embodiments, the inter-network facilitation system 704 may be capable of linking a variety of entities. As an example, and not by way of limitation, the inter-network facilitation system 704 may enable users to interact with each other or other entities, or to allow users to interact with these entities through an application programming interfaces (“API”) or other communication channels.

In particular embodiments, the inter-network facilitation system 704 may include a variety of servers, sub-systems, programs, modules, logs, and data stores. In particular embodiments, the inter-network facilitation system 704 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 704 may also include suitable components such as network interfaces, security mechanisms, load balancers, failover servers, management-and-network-operations consoles, other suitable components, or any suitable combination thereof. In particular embodiments, the inter-network facilitation system 704 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 704 and one or more client devices 1004. An action logger may be used to receive communications from a web server about a user’s actions on or off the inter-network facilitation system 704. In conjunction with the action log, a third-party-content-object log may be maintained of user exposures to third-party-content objects. A notification controller may provide information regarding content objects to a client device 1004. Information may be pushed to a client device 1004 as notifications, or information may be pulled from client device 1004 responsive to a request received from client device 1004. Authorization servers may be used to enforce one or more privacy settings of the users of the inter-network facilitation system 704. A privacy setting of a user determines how particular information associated with a user can be shared. The authorization server may allow users to opt into or opt out of having their actions logged by the inter-network facilitation system 704 or shared with other systems, such as, for example, by setting appropriate privacy settings. Third-party-content-object stores may be used to store content objects received from third parties. Location stores may be used for storing location information received from client devices 1004 associated with users.

In addition, the third-party system 1006 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 704 via the network 1002. A third-party system 1006 can communicate with the inter-network facilitation system 704 to provide financial information pertaining to balances, transactions, and other information, whereupon the inter-network facilitation system 704 can provide corresponding information for display via the client device 1004. In particular embodiments, a third-party system 1006 communicates with the inter-network facilitation system 704 to update account balances, transaction histories, credit usage, and other internal information of the inter-network facilitation system 704 and/or the third-party system 1006 based on user interaction with the inter-network facilitation system 704 (e.g., via the client device 1004). Indeed, the inter-network facilitation system 704 can synchronize information across one or more third-party systems 1006 to reflect accurate account information (e.g., balances, transactions, etc.) across one or more networked systems, including instances where a transaction (e.g., a deposit) from one third-party system 1006 affects another third-party system 1006.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
determining an available resource delimiter for a user account according to an accumulation rate and an accumulation period associated with the user account;
generating, for display within a user interface on a client device, a resource accessibility dial comprising an interactive element selectable to modify a resource quantity accessible by the user account, wherein the resource accessibility dial is divided into a first section indicating resource availability up to the available resource delimiter and a second section indicating projected resource availability above the available resource delimiter;
receiving, from the client device, a user interaction with the resource accessibility dial modifying the resource quantity indicated by the resource accessibility dial; and
updating, within the user interface on the client device, the resource accessibility dial to reflect a modified resource quantity according to the user interaction.

2. The computer-implemented method of claim 1, wherein generating the resource accessibility dial comprises:
generating the first section comprising a first set of pixels reflecting a first format; and
generating the second section comprising a second set of pixels reflecting a second format visually distinct from the first format.

3. The computer-implemented method of claim 1, wherein generating the resource accessibility dial comprises:
generating, for display as part of the resource accessibility dial, a third section indicating an unavailable resource quantity, wherein the third section is separated from the first section by an unavailable resource delimiter and the first section is separated from the second section by the available resource delimiter; and
modifying a size of the first section according to the unavailable resource quantity.

4. The computer-implemented method of claim 1, wherein receiving the user interaction with the resource accessibility dial further comprises:
receiving a circular swipe interaction along an arc of the resource accessibility dial to set the resource quantity.

5. The computer-implemented method of claim 4, wherein the circular swipe interaction extends beyond the available resource delimiter to define the resource quantity including an available amount and a projected amount.

6. The computer-implemented method of claim 1, wherein determining the available resource delimiter comprises determining an accumulation of resources associated with the user account according to the accumulation rate at a point in time within the accumulation period.

7. The computer-implemented method of claim 1, further comprising:
generating a preview of the resource accessibility dial for display within an overview user interface; and
generating the resource accessibility dial for display within the user interface responsive to receiving a user interaction with the preview of the resource accessibility dial.

8. A system comprising:
at least one processor; and
at least one non-transitory computer-readable storage medium storing instructions that, when executed by the at least one processor, cause the system to:
determine an available resource delimiter for a user account according to an accumulation rate and an accumulation period associated with the user account;
generate, for display within a user interface on a client device, a resource accessibility dial comprising an interactive element selectable to modify a resource quantity accessible by the user account, wherein the resource accessibility dial is divided into a first section indicating resource availability up to the available resource delimiter and a second section indicating projected resource availability above the available resource delimiter;
receive, from the client device, a user interaction with the resource accessibility dial modifying the resource quantity indicated by the resource accessibility dial; and
update, within the user interface on the client device, the resource accessibility dial to reflect a modified resource quantity according to the user interaction.

9. The system of claim 8, further comprising instructions that, when executed by the at least one processor, cause the system to:
generate the first section comprising a first set of pixels reflecting a first format; and
generate the second section comprising a second set of pixels reflecting a second format visually distinct from the first format.

10. The system of claim 8, further comprising instructions that, when executed by the at least one processor, cause the system to:
generate for display as part of the resource accessibility dial, a third section indicating an unavailable resource quantity, wherein the third section is separated from the first section by an unavailable resource delimiter and the first section is separated from the second section by the available resource delimiter; and
modify a size of the first section according to the unavailable resource quantity.

11. The system of claim 8, further comprising instructions that, when executed by the at least one processor, cause the system to:
receive a circular swipe interaction along an arc of the resource accessibility dial to set the resource quantity.

12. The system of claim 11, wherein the circular swipe interaction extends beyond the available resource delimiter to define the resource quantity including an available amount and a projected amount.

13. The system of claim 8, further comprising instructions that, when executed by the at least one processor, cause the system to determine an accumulation of resources associated with the user account according to the accumulation rate at a point in time within the accumulation period.

14. The system of claim 8, further comprising instructions that, when executed by the at least one processor, cause the system to:
generate a preview of the resource accessibility dial for display within an overview user interface; and
generate the resource accessibility dial for display within the user interface responsive to receiving a user interaction with the preview of the resource accessibility dial.

15. A non-transitory computer-readable medium storing instructions that, when executed by at least one processor, cause the at least one processor to:
determine an available resource delimiter for a user account according to an accumulation rate and an accumulation period associated with the user account;
generate, for display within a user interface on a client device, a resource accessibility dial comprising an interactive element selectable to modify a resource quantity accessible by the user account, wherein the resource accessibility dial is divided into a first section indicating resource availability up to the available resource delimiter and a second section indicating projected resource availability above the available resource delimiter;
receive, from the client device, a user interaction with the resource accessibility dial modifying the resource quantity indicated by the resource accessibility dial; and
update, within the user interface on the client device, the resource accessibility dial to reflect a modified resource quantity according to the user interaction.

16. The non-transitory computer-readable medium of claim 15, further storing executable instructions which, when executed by the at least one processor, cause the at least one processor to:
generate the first section comprising a first set of pixels reflecting a first format; and
generate the second section comprising a second set of pixels reflecting a second format visually distinct from the first format.

17. The non-transitory computer-readable medium of claim 15, further storing executable instructions which, when executed by the at least one processor, cause the at least one processor to:
generate for display as part of the resource accessibility dial, a third section indicating an unavailable resource quantity, wherein the third section is separated from the first section by an unavailable resource delimiter and the first section is separated from the second section by the available resource delimiter; and
modify a size of the first section according to the unavailable resource quantity.

18. The non-transitory computer-readable medium of claim 15, further storing executable instructions which, when executed by the at least one processor, cause the at least one processor to:
receive a circular swipe interaction along an arc of the resource accessibility dial to set the resource quantity.

19. The non-transitory computer-readable medium of claim 15, further storing executable instructions which, when executed by the at least one processor, cause the at least one processor to determine an accumulation of resources associated with the user account according to the accumulation rate at a point in time within the accumulation period.

20. The non-transitory computer-readable medium of claim 15, further storing executable instructions which, when executed by the at least one processor, cause the at least one processor to:
generate a preview of the resource accessibility dial for display within an overview user interface; and
generate the resource accessibility dial for display within the user interface responsive to receiving a user interaction with the preview of the resource accessibility dial.
